(19) United States
(12) Patent Application Publication
(10) Pub. No.: US 2017/0330145 A1
(43) Pub. Date: Nov. 16, 2017

(54) SECURED DELIVERY SYSTEMS AND DEVICES

(71) Applicant: PayPal, Inc., San Jose, CA (US)

(72) Inventor: Todd Murray Studnicka, San Jose (UA)

(21) Appl. No.: 15/156,053

(22) Filed: May 16, 2016

(51) Int. Cl. G06Q 10/08; G07C 9/00; H04L 9/32; H04L 9/08

(52) U.S. Cl. CPC G06Q 10/0836; H04L 9/3234; H04L 9/0863; G06Q 10/0832; G06Q 10/0833; G07C 9/00015

(57) ABSTRACT

Systems and methods for providing secured delivery include identifying a transaction that includes a physical delivery of an item to a user-specified location; responsive to the identifying, obtaining an access token based at least in part on one or more access restrictions associated with the user-specified location; and making the access token available to a party associated with the physical delivery of the item. The access token enables the party to enter a predefined secured subarea within the user-specified location.

### TECHNICAL FIELD

The present disclosure relates generally to secured delivery system and devices, and in particular, to a system that enables automated secure delivery of goods or services to a physical location.

### BACKGROUND

Tracking tools, e.g., online status checkers, have been used by delivery companies and users expecting deliveries to ensure that goods are accurately delivered to a user-provided location. Difficulties for securing goods at a user-provided location as part of a delivery process still abound, however.

For example, when a user is not at home, a delivery person may have to either drop off a package unsecured or unattended (e.g., the home's front door or porch) or reschedule the delivery to a different day on which the user might be present to accept the delivery in person. The delivery company therefore can face the dilemma of having to choose between efficiency and security. The user is also inconvenienced, as she has to either be physically present to accept the delivery or bear the burdens caused by a delivery reschedule.

There is therefore a need for a device, system, and method that allow the secured delivery of goods or services without unduly burdening a user or a delivery entity.

### BRIEF DESCRIPTION OF THE FIGURES

FIG. 1 is a schematic view illustrating an embodiment of a system for providing secured deliveries.

FIG. 2 is a schematic view illustrating an embodiment of a system for providing secured deliveries.

FIGS. 3A-3B are flow charts illustrating an embodiment of a method for providing secured deliveries.

FIG. 4 is a flow chart illustrating an embodiment of a method for providing secured deliveries.

FIG. 5 is a schematic view illustrating an embodiment of a delivery service system.

FIG. 6 is a schematic view illustrating an embodiment of a user device.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure provides mobile devices, systems, and methods for secured delivery of goods or services. In an embodiment, after receiving a user payment associated a transaction (e.g., an online transaction or an in-store transaction) to purchase one or more products or items, a service provider (which may be the seller/merchant or a payment provider) may determine that the transaction includes a physical delivery of a product (e.g., a laptop) to a user's home or office. The service provider may, based on information (e.g., a password to the user's home security system) stored in a user profile, generate an access token for the delivery location. The access token can encode an expiration time, an access time range, a specific location of access at the location, or other use restrictions. The service provider can transfer the access token to a party (e.g., a drone or a delivery person) delivering the product. The delivering party can then use the access token to access a secure area within the home, for example, a locked garage, a locked window, a locked side door, and/or a locked gate. The delivering party can drop off the product in the secure area and notify the user that the delivery has been completed. After delivery, such as upon detection or notification the delivering party is no longer in the secure area, the secure area may be automatically re-secured.

The systems and methods described in the present disclosure can provide a variety of technical advantages. In some embodiments, redundant or inefficient data processing on and communications between a user device and a delivery system may be reduced. For example, knowing that an order would be delivered—and more importantly secured after the delivery, a user might not use her user device to repeatedly inquire about delivery status from a delivery status database or online status tracker.

In some embodiments, unnecessary data processing on a delivery device may also be reduced. For example, a successful secured delivery can reduce or eliminate the need for storing detailed delivery status updates, which are often contractually required to show that one or more delivery attempts have occurred within a required time frame.

Additional details of implementations are now described in relation to the Figures.

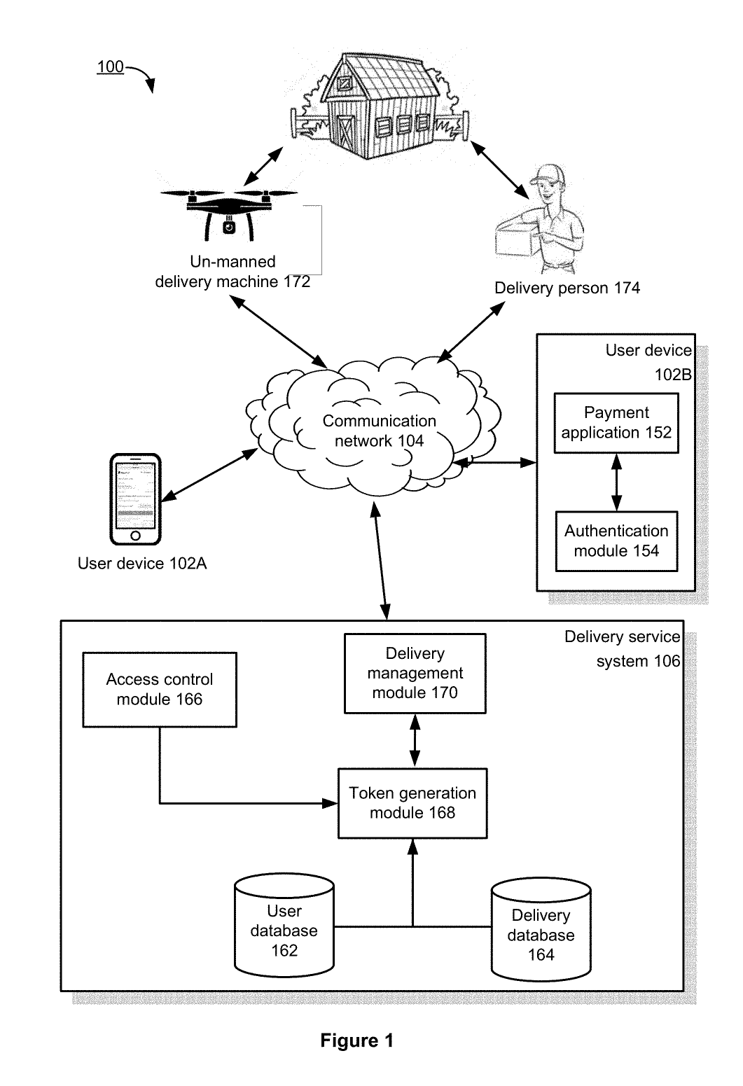

FIG. 1 is a schematic view illustrating an embodiment of a system 100 for providing secured deliveries. The system 100 may comprise or implement a plurality of servers and/or software components that operate to perform various technologies provided in the present disclosure.

As illustrated in FIG. 1, the system 100 may include a plurality of devices 102 (e.g., 102A and 102B), a delivery service system 106, and a delivery device (e.g., an un-manned delivery machine 172 and a mobile device carried by a delivery person 174) in communication over a communication network 104.

In one embodiment, the device 102 (also referred to as a user device in the present disclosure) may enable a user to initiate a transaction e.g., with a merchant, and when the transaction includes a delivery of an item (e.g., a product or a service), communicate with the delivery service system 108, via the communication network 104.

In some embodiments, the device 102 may include a payment application 152 for a user to make payments to another party, for example, a merchant or another user. The payment application 152 may be used, for example, to initiate a payment from a user account (e.g., maintained by a payment service system) to a payee (e.g., a merchant) over the communication network 104. The payment application 152 may be implemented as a smartphone app or a web browser.

The user device 102 may also include an authentication application 154 which may be used to authenticate a user on the user device 102. In one embodiment, the authentication application 154 may collect credentials from a user and compare the collected credentials with previously accepted credentials to determine whether to authenticate a user on the user device. For example, the authentication application 154 may (1) collect, from a user, a user or device identifier such as an email address, device ID, or user name, a password or PIN, an audio/video fingerprint, biometric data (e.g., voice, fingerprint, gesture), or other credential information, (2) match credential information to previously accepted or stored credential information, and (3) authenticate the user when a match occurs. The user device 102 may be implemented as a smart phone, a tablet computer, a laptop computer, a personal computer, or other computing devices.

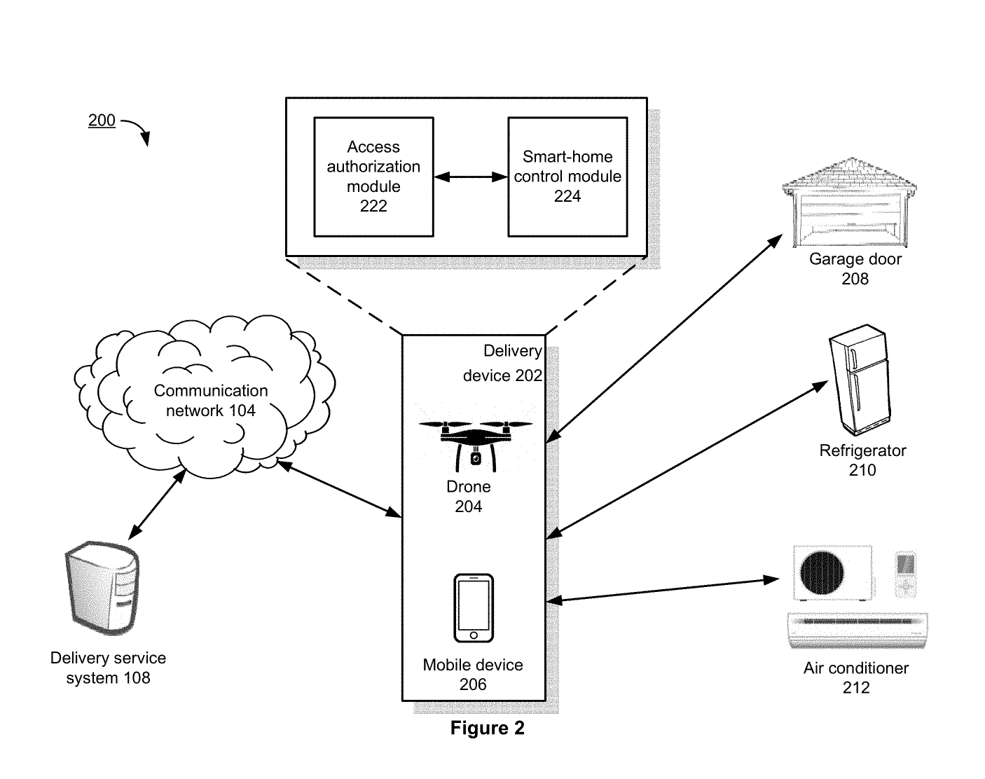

In some implementations, the communication network 104 interconnects one or more of the user devices 102 with each other, with the delivery service system 106, and/or with a delivery device 202 (as shown in FIG. 2). In some implementations, the communication network 104 optionally includes the Internet, one or more local area networks (LANs), one or more wide area networks (WANs), other types of networks, or a combination of such networks.

In an embodiment, the delivery service system 106 identifies information relating to a transaction and generates an access token in accordance with the information to enable a secure delivery of an item to a user-provided location, for example, at a home or office where a user may not be present to personally accept the delivery during the delivery time.

In an embodiment, the delivery service system 106 may include a user database 162, a delivery database 164, an access control module 166, a token generation module 168, and a delivery management module 170, discussed in further detail below. The delivery service system 106 and the delivery device 202 (as shown in FIG. 2) may include devices operated by or accessible to a payment service provider, for example, the PayPal Inc. of San Jose, Calif.

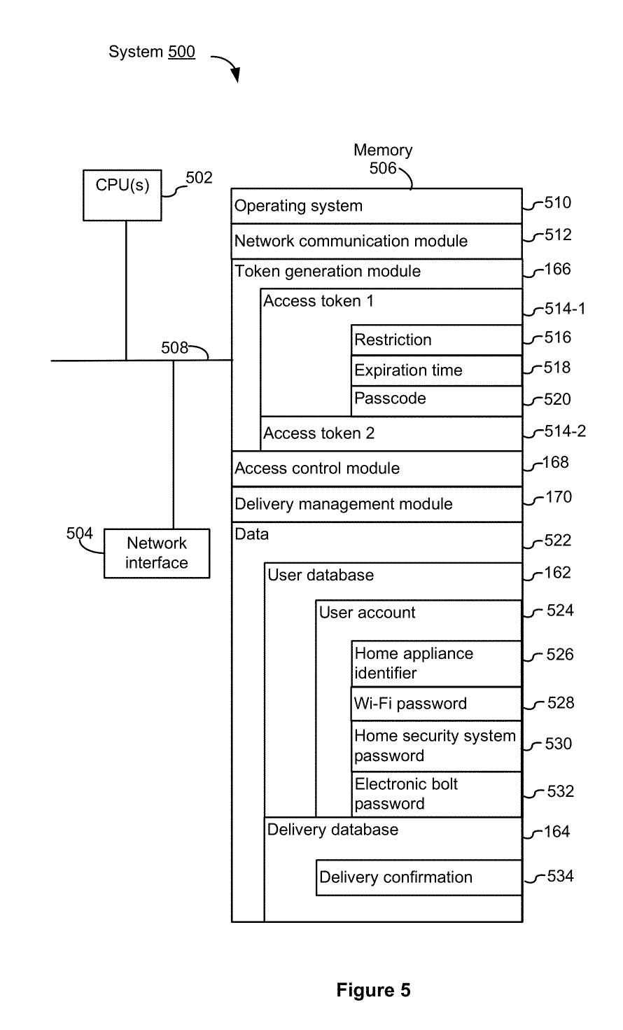

The user database 162 may store information identifying one or more user accounts 524 (as shown in FIG. 5). A user account 524 may include: one or more home appliance identifiers 526, a home network (e.g., a Wi-Fi) password 528, a home security system password 530, and an electronic locking device (e.g., a bolt) password 532.

The delivery database 164 may store information identifying one or more deliveries (e.g., physical or digital, and in person or online), for example, one or more delivery status updates and a delivery confirmation (e.g., a text, an image, or a video clip).

The access control module 166 may identify (1) one or more access restrictions that need to be removed to complete a physical delivery of an item and (2) one or more use restrictions on an access token. For example, the access control module 166 may determine that to securely deliver a box of frozen seafood during a summer season, while a user is not present, a delivery party (e.g., a drone or a delivery person) may need to not only open a garage door (to enter the user's house), but also unlock a freezer in the garage so that the frozen seafood can be properly stored. In this example, the garage door and the freezer lock can be considered as access restrictions.

In another example, the access control module 166 may determine that, for a user's safety or other reason, an access token should not allow a delivery party to enter any locked area of the user's house from 11 pm to 6 am on any weekday. In this example, the 11 pm to 6 am time frame and the weekday requirements limit the use of an access token and therefore can be considered as use restrictions on the access token.

Based on an access restriction, a use restriction, or both, the token generation module 168 may generate one or more access tokens. For example, the token generation module 168 can generate a one-time password to a user's home security system, and a delivery person can use the one-time password to disable the home security system (e.g., for the duration of a delivery) and to unlock the user's locked garage side door. In some embodiments, the token generation module 168 may generate an access token by communicating with a user's smart-home system or home security system and requesting one or more passwords therefrom.

In some embodiments, the token generation module 168 may generate an access token in accordance with one or more encryption and decryption algorithms (e.g., symmetric or asymmetric). A public key and private key pair may be used to encrypt and decrypt an access token. For example, the token generation module 168 may encrypt a password to a user's home security system with a public key and transmits the encrypted password to a delivery drone. When gaining access to the user's home for a secure delivery, the delivery drone may use a corresponding private key to decrypt the encrypted password and use the decrypted password to disarm the user's home security system.

In some embodiments, a symmetric encryption/decryption algorithm may be used. For example, the token generation module 168 may encrypt a user's home security system password in accordance with a key (known to both the user's home security system and the delivery service system). When gaining access to the user's home for a secure delivery, a delivery person may provide the encrypted password to the user's home security system, which may decrypt the encrypted password with the same key.

The delivery management module 170 may (1) manage delivery activities, for example, maintaining delivery status updates provided by a delivery device in the delivery database 164 and (2) provide access to these status updates by a user device. The delivery management module 170 may also manage access tokens generated by the token generation module 168. The delivery management module 170, for example, may revoke an access token because a delivery has been canceled or the delivery has been completed or may modify a use restriction on an access token because a user's availability has changed.

FIG. 2 is a schematic view illustrating an embodiment of a system 200 for providing secured deliveries.

As shown in FIG. 2, the system 200 may include the delivery service system 108, one or more delivery devices 202, and one or more (e.g., home or office) appliances.

A home (or office) appliance may be an equipment present at a user-specified location, for example, a garage door 208, a refrigerator 210, and an air conditioner 212. A home appliance may be associated with an access restriction, which needs to be removed for a delivery party to access (e.g., unlock or power-on) the appliance. For example, an access restriction associated with the garage door 208 may be an electronic password-controlled lock on the garage door 208; an access restriction associated with the refrigerator 210 may be a temperature control unit that can change the temperature settings on the refrigerator 210; and an access restriction associated with the air conditioner 212 may be a wireless login interface, provided by the user's smart-home system, that can turn on/off the cooling mode on the air conditioner 212. Other locations for access may include a window, a gate, a lock for a room within the delivery location (e.g., a bedroom within a house or an office within a floor), and the like.

The delivery device 202 may be an automatic delivery machine that can deliver an item to a user-specified location when properly programmed. In some embodiments, a delivery device may be a drone that can deliver an item to a shipping address, for example, provided by a user as part of an online transaction.

The delivery device 202 may also be a mobile (e.g., handheld) device that a human user can use to communicate with one or more home appliances. In some embodiments, a delivery device may be a smartphone equipped with a wireless communication module (e.g., an NFC module, a Bluetooth module, and a Wi-Fi module), through which a delivery person can turn on or off a user's home security system, lock or unlock an electronic lock, or modify temperate settings on a user's central air conditioning system.

In some embodiments, a delivery device 202 may include an access authorization module 222 and a smart-home control module.

The access authorization module 222 may determine, based on one or more use restrictions placed on an access token, whether a delivery party can use a given access token to remove an access restriction during a delivery.

For example, if a password is being used to unlock a user's front door at 5 am on a weekday, and when one of the use restrictions of the password specifies that the password shall not be valid between 10 pm and 9 am during a weekday, the access authorization module 222 will deny the attempted use of the password as unauthorized. As a result, a delivery party would not gain access to the user's front door using the password under these circumstances.

In another example, if a programming command is being used by a delivery drone to turn on the cooling mode of a user's air conditioning system when the room temperature is approximately 20 degrees Fahrenheit, and when one of the use restrictions of the programming command specifies that the programming command shall not be valid when the home temperature is below 45 degrees Fahrenheit, the access authorization module 222 will deny the attempted invocation of the programming command by a delivery device on the user's air conditioning system.

Implementing use restrictions on an access token (rather than relying on an appliance to reject an attempted access) is technically advantageous. First, user confidence in the delivery service system can be enhanced if a user can place restrictions on an external device (e.g., a delivery device), rather than having to safeguard her own appliances. Second, delivery devices can be more easily programmed compared to home appliances. Third, a delivery service system can remotely, e.g., through a cellular network, manage a delivery device (and the access authorization module therein) and modify use restrictions of an access token, e.g., when a user is making a last-minute change to a delivery.

The smart-home control module 224 may remove an access restriction of an appliance present at a user-specific location (e.g., an office building, a home residence, and a public locker), responsive to an authorization by the access authorization module 222.

The smart-home control module 224 may provide an Application Programming Interface (API) that is capable of communicating with one or more predefined types of appliances. For example, the smart-home control module 224 may generate a specific instruction that is capable of communicating with an appliance based on an access token. For example, when a delivery person is showing a QR code displayed on her smartphone to a door camera, and when this attempted use of the QR code to access a user's home security system is deemed authorized, the smart-home control module 224 may generate a command capable of accessing the user's home security system. These technologies are technically advantageous, because the smart-home control module 224 (or the firmware stored thereon) can be updated periodically to enable access to new appliances or equipment, without requiring modifications to other components of the delivery device 202 or the delivery system 108. Furthermore, control of security systems can be more automated and secure, without the owner of the security system having to manually enter security codes or provide security codes to others, which may be shared with others, reused, or otherwise compromise the security system.

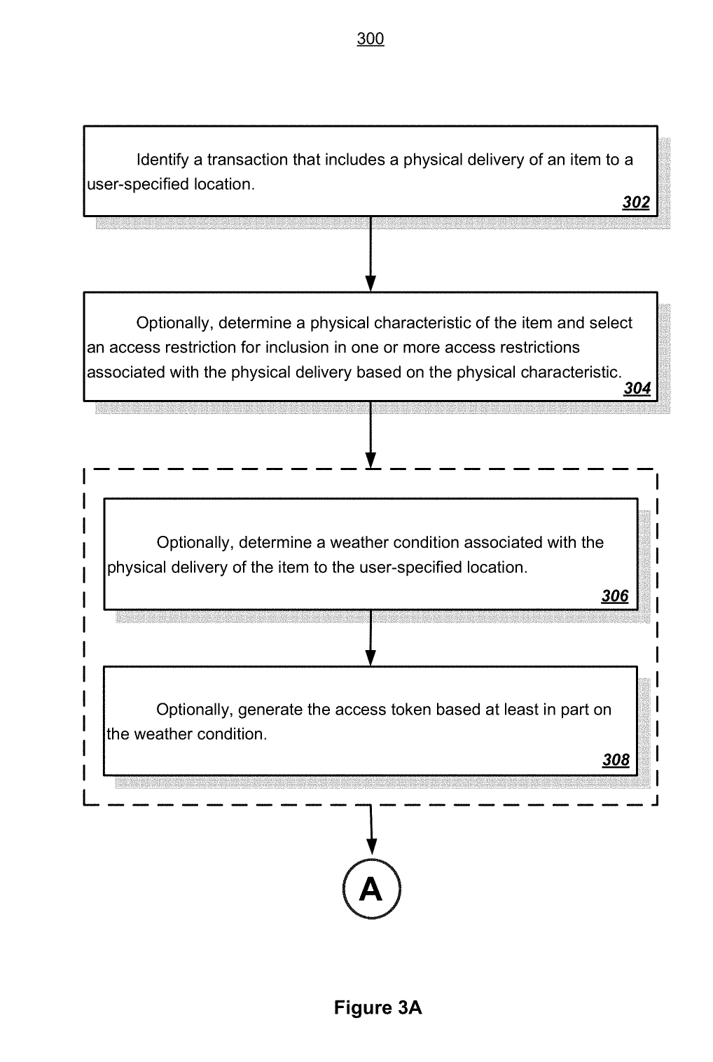

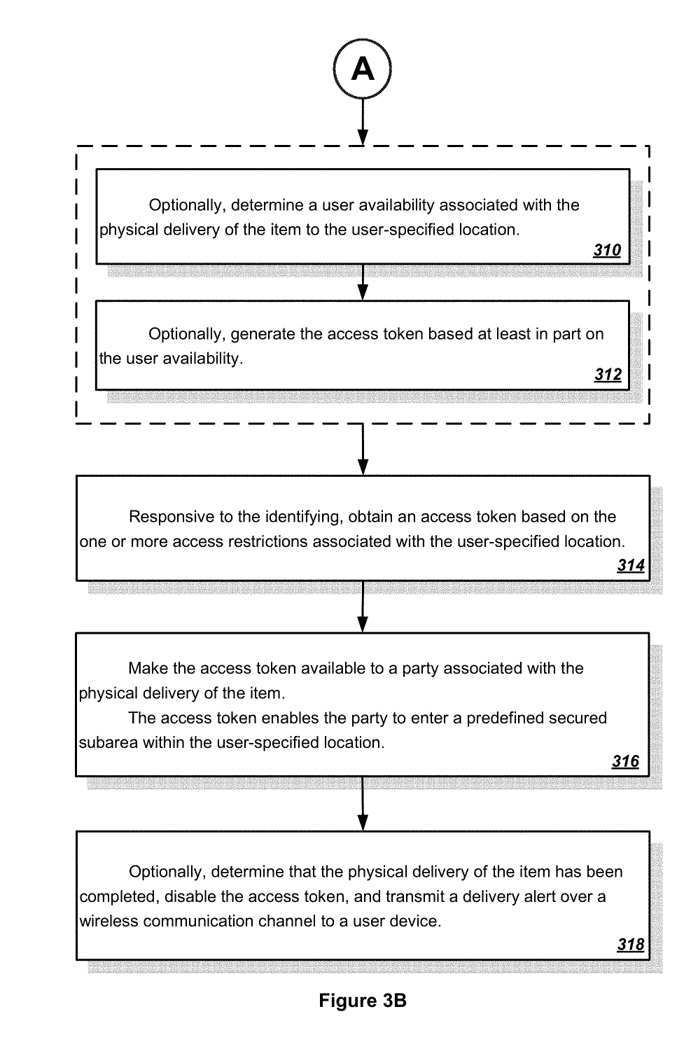

FIG. 3A-3B are flow charts illustrating an embodiment of a method 300 for providing, conducting, or processing secured deliveries. The delivery service system 108, for example, when programmed in accordance with the technologies described in the present disclosure, can perform the method 300.

In some embodiments, a delivery system can analyze (e.g., using a text or image recognition technique) transaction details to identify (302) a transaction as including a physical delivery of an item to a user-specified location. The transaction details may include a shipping address, including a specific way to access the shipping address (such as a garage door, the front door, a side door, a window, a gate, etc.), a billing address, and a product description; the item can be either goods (e.g., a box of fruits) or service (e.g., cleaning carpets at a user's office). The transaction details may also include a specific location (e.g., specific office, specific room in house, into or on a specific appliance, etc.) within the shipping address for delivery or placement, along with any special instructions for delivery.

For example, after textually analyzing an order confirmation email, a delivery service system may identify that the keyword “book” and the phrase “105 Beach Park Blvd, Foster City, Calif. 94404” are present in the email. Based on the identification of these keywords, the delivery service system may determine that fulfilling the order includes physically delivering a book to 105 Beach Park Blvd, Foster City, Calif. 94404.

For another example, after applying an image recognition technique (e.g., an OCR technique) to a message received from an online seller, a delivery system may find an image representing an adult bicycle and another image representing a delivery process bar (e.g., showing the delivery as being 0%, 25%, and 50% completed) present in the message. Based on the identification of these images, the delivery service system may determine that the seller is requesting a delivery of an adult bicycle to a user-specified location.

In some embodiments, a delivery service system may, responsive to the identifying (302), obtain (314) an access token based at least in part on one or more access restrictions associated with the user-specified location. Some example access restrictions may include: a home security system, an electronic lock, an electronic bolt, a door, a window, and a ceiling opening.

To continue with the “book” example above, based on information stored in a user account or profile (with a payment or delivery service provider), a delivery service system may determine that the delivery address is a user's home address (e.g., as identified by a “home” tag) and that the user has a locked mail box capable of storing the book securely. The delivery service system may determine that the electronic lock on the mail box needs to be unlocked first, however, in order to effectuate the secure delivery. In this example, the delivery service system may consider the electronic lock on the mail box an access restriction.

To continue with the “adult bicycle” example above, based on information stored in a user's account registered with a residential/commercial building security service provider, a delivery service system may determine (1) that the delivery address is a business located on the second floor of a commercial building and (2) that the delivery entry to the commercial building requires an access code. The delivery service system may determine that the delivery entry needs to be unlocked first, however, in order to effectuate the secure delivery. In this example, the delivery service system may consider the locked delivery entry an access restriction.

In some embodiments, a smart-access feature is provided, for example, to minimize any perceived intrusion to a user-specified delivery location. For example, when there are multiple ways to effectuate a secure delivery of an item, the delivery system may take into account an item's size or nature to select a delivery method that is either less intrusive to a user or more suitable for not only securely, but also properly, storing the item being delivered.

In some embodiments, therefore, the delivery service system may determine (304) a physical characteristic of the item; and identify an access restriction from the one or more access restrictions based on the physical characteristics of the item.

For example, after determining that the item being delivered is a textbook having the 9 (L)×6 (W)×1 (H) inches dimensions, the delivery service system may request an access code for unlocking a user's mail box, rather than opening the user's garage or backyard door. Because, the user may perceive the latter as more intrusive or likely to jeopardize security at the delivery location.

In another example, after determining that the item being delivered is a box of frozen yogurt, which needs to be kept frozen, the delivery service system may request an access code that can grant access to the user's living room or garage where a freezer is located and unlock the freezer (if necessary), rather than an access code for unlocking the user's mailbox or a pathway to the user's open backyard.

Similarly, the delivery service system may take into account the weather conditions under which a delivery is likely to occur, when generating the access token. In some embodiments, therefore, the delivery service system may determine (306) a weather condition associated with the physical delivery of the item to the user-specified location and obtain (308) the access token based at least in part on the weather condition.

For example, after determining (e.g., based on textual keyword analysis of an order confirmation email) that the item being delivered is a bag of cement, which needs to be kept dry, the delivery service system may query weather conditions of an expected delivery time and date (e.g., from a weather service provider, such as a website that provides estimates of high or low temperature, likelihood of precipitation, and wind condition during a given time frame of a given day). After determining that it is likely to rain on the day the bag of cement is going to be delivered, the delivery service system may generate an access code that can open a user's covered garage or storage shack, rather than an access code that can lead to only the user's open backyard.

In some embodiments, after generating the access code or obtaining the access code from a third party (e.g., a user's home security system), the delivery service system makes the access token available to a party associated with the physical delivery of the item.

For example, the delivery service system may transmit, e.g., through the Internet or a cellular network, the access token to a delivery drone or a delivery person's mobile device. The delivery service system may transmit the access token to a delivery drone or a delivery person's mobile device based on determining that the delivery drone or the delivery person's mobile device is within a predefined proximity to a user-specified location (e.g., 1 or 2 miles away from a user's home). This feature is sometimes referred to as providing an access token as needed.

This is technically advantageous, because unnecessary data communications can be reduced. For example, if a user cancels or reschedules a delivery, the delivery service system may not need to generate or transmit the access token to a delivery device or a deliver person's mobile device. This is particularly advantageous when the access token is generated based on conditions that can vary from time to time, e.g., weather conditions and user availability.

Also, user confidence is enhanced if an access token that can grant access to a user's home is provided on an as-needed basis. Users may be more likely to use the delivery service system, perceiving that the system passes along sensitive information (e.g., an access code) to a third party only when needed.

In some embodiments, the access token may enable the delivery party to enter a predefined secured subarea (e.g., a portion of an area) within the user-specified location. In some embodiments, a user can customize an access token and consequently how a delivery person or device may access the user-specified location.

For example, a user expecting the delivery (as opposed to the delivery service system) can limit one or more subareas into which a delivery drone or person can enter. For example, irrespective of the weather condition factor discussed above, a user can limit a delivery person's access to the user's backyard area and deny access to the user's locked garage. This access-customization feature can further improve user confidence in the delivery service system due to the user perception that access to a user-specified location is controlled by the user.

In some embodiments, the delivery service system can generate or obtain an access token based on a user's availability (e.g., at the delivery location). For example, the delivery service system may determine (310) a user availability associated with the physical delivery of the item to the user-specified location; and generate (312) the access token based at least in part on the user availability.

In some embodiments, the access token does not enable entry to the predefined secured subarea during a time frame within the user availability.

For example, the delivery service system can affirmatively restrict the use of an access token to time periods where a user is not available to accept a delivery in person at the delivery location, because an in-person acceptance may reduce or eliminate the need to grant, a delivery person or device, access to the delivery location. For example, if a user is available at her home to accept a delivery on a given Friday, the delivery service system may not grant, a delivery person, access to the user's apartment front door during that given Friday.

In some embodiments, determining the user availability comprises determining the user availability, without user input, from a user appointment recording application.

For example, the delivery service system can access a user's electronic calendar and determine the user's availability (or lack thereof) based on the user's appointments recorded in the calendar.

In some embodiments, the delivery service system provides a delivery confirmation and disables the access token, after determining that a successful delivery has occurred. This can inform a user not only that a secure delivery has taken place, but also that one or more access restrictions removed during the delivery have now been restored.

In some embodiments, therefore, the delivery service system may determine that the physical delivery of the item has been completed (e.g., based on a delivery person or device's confirmation); responsive to the determining, disable the access token; and transmit a delivery alert over a wireless communication channel to a user device.

In some embodiments, the delivery service system may provide a delivery confirmation by presenting a delivery alert on a user device (e.g., a smartphone of the user requesting the delivery). The delivery information may comprise a photo or video confirmation of the physical delivery.

The delivery alert, when selected (e.g., clicked) may activate a delivery status viewing application to cause delivery information to be displayed on the user device when the user device is connected with the system through a predefined communication channel.

For example, the delivery service system may, e.g., through a cellular network, present a pop-up notification on a user's smartphone and when the user's smartphone is connected to the delivery database, e.g., through a Wi-Fi connection, the pop-up notification can automatically invoke a smartphone app on the user's smartphone and display delivery status detail and a video delivery confirmation. These technologies are advantageous, because they can selectively determine whether to display delivery detail, which includes more data than the notification, thereby avoiding generating a large amount of network traffic over a less preferred (e.g., more expensive or congested) communication channel.

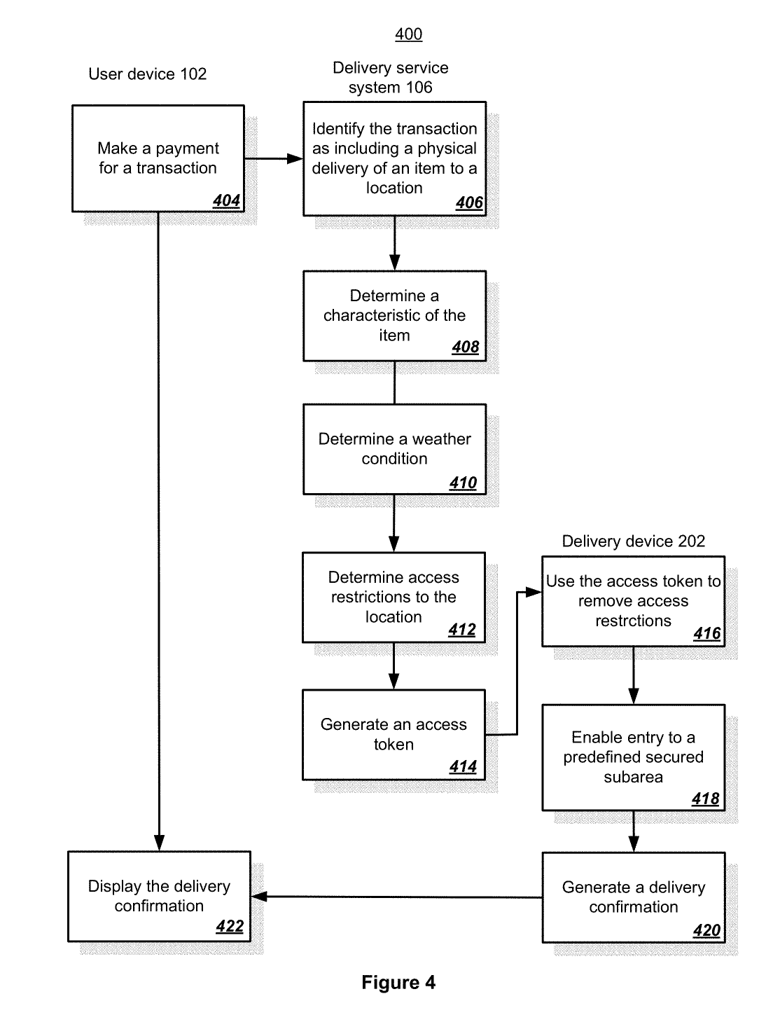

FIG. 4 is a flow chart illustrating an embodiment of a method 400 for providing, conducting, or processing secured deliveries. The delivery service system 108, for example, when programmed in accordance with the technologies described in the present disclosure, can perform the method 400.

In some implementations, the method 400 includes detecting that a user, through a user device, is making or has made (404) a payment for a transaction. For example, the delivery service system may be notified by a merchant device, e.g., by way of an email or other electronic message, that a user has completed an online purchase of a box of chocolate. The notification may include transaction details (e.g., which items the user has purchased) and delivery details (e.g., delivery address and user availability, or lack thereof, for accepting in-person deliveries).

In some implementations, the method 400 includes identifying (406) an online or in-store transaction as a transaction that includes a physical delivery of an item to a user-specified location.

In some implementations, the method 400 optionally includes determining (408) a characteristic of the item, e.g., a physical dimension of the item, a storage condition (e.g., temperature requirement), or other special handling instructions of the items at the user-specified location after the delivery.

The method 400 may additionally include determining (410) a weather condition of an expected day or time of the delivery of the item, e.g., humidity, likelihood of precipitation, windiness, or sunshine condition.

The method 400 includes, in some implementations, based on the determined weather condition or the determined characteristic of the item, determining (412) one or more access restrictions to the user-specified location.

After determining the access restrictions, the method 400 includes generating (414) an access token or obtaining an access token generated and provided from a third party (e.g., a user's home security control system). The access token can remove the one or more access restrictions identified in the step 412. The method 400 also includes transmitting, e.g., through a wireless communication network, the access token to a delivery device (e.g., a delivery drone or a mobile device carried by a delivery person).

Having received the access token from the delivery service system, the delivery device can use the access token to remove (416) access restrictions to effectuate a secure delivery of the item at the user-specified location.

After removing the access restrictions, the delivery device or a user associated therewith can enter (418) a predefined secure subarea of the user-specified location. And once finishing the delivery, the delivery device can generate a delivery confirmation, e.g., a text message informing a user that the “delivery has been completed,” an image showing that a box of clothing has been placed in a user's walk-in closet, and a video clip showing that a book has been dropped by a delivery drone on a user's master bedroom balcony. The delivery device may transmit the delivery confirmation to the user device, which in turn may display (422) the delivery confirmation for a user to review. In other embodiments, the delivery device may be detected as leaving the delivery location, which may then cause the access token to be automatically disabled or revoked. Once disabled or revoked, the accessed area(s) may be secured again, such as by locking, turning on an alarm, or otherwise securing access.

In another embodiment, a method comprises: receiving transaction data for a purchase of an item to be delivered, wherein the transaction data comprises a delivery location; obtaining access data for the delivery location; generating an electronic access token based on the access data and the transaction data; and communicating the electronic access token to a device associated with a delivery of the item to the delivery location. The electronic access token enables limited access to a first access location of the delivery location.

In some embodiments, the method further comprises: determining the device has accessed the first access location; and responsive to the determining, disabling the electronic access token.

In some embodiments, the method further comprises: responsive to the determining, securing the first access location.

In some embodiments, the method further comprises: generating the electronic access token includes generating the electronic access token in accordance with a symmetric encryption-decryption algorithm.

In some embodiments, communicating the electronic access token to the device includes: encrypting a password associated with the delivery location to produce the electronic access token; and transmitting a key associated with the symmetric encryption-decryption algorithm to the device.

In some embodiments, communicating the electronic access token to the device includes: determining that the device is within a predefined proximity to the delivery location; and responsive to the determining, communicating the electronic access token to the device.

In some embodiments, the transaction data includes one of: a time frame associated with the delivery, an address of the delivery location, and an operating time of the delivery location.

FIG. 5 is a schematic view illustrating an embodiment of a delivery service system 500, which can be the delivery service system 106 shown in FIG. 1. The system 500 in some implementations includes one or more processing units CPU(s) 502 (also referred to as hardware processors), one or more network interfaces 504, a memory 506, and one or more communication buses 508 for interconnecting these components. The communication buses 508 optionally include circuitry (sometimes called a chipset) that interconnects and controls communications between system components. The memory 506 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 506 optionally includes one or more storage devices remotely located from the CPU(s) 502. The memory 506, or alternatively the non-volatile memory device(s) within the memory 506, comprises a non-transitory computer readable storage medium. In some implementations, the memory 506 or alternatively the non-transitory computer readable storage medium stores the following programs, modules and data structures, or a subset thereof:
an operating system 510, which includes procedures for handling various basic system services and for performing hardware dependent tasks;
a network communication module (or instructions) 512 for connecting a delivery service system 106 with other devices (e.g., a delivery device 202 or a user device 102) via one or more network interfaces 504;
a token generation module 166 for generating or obtaining one or more access tokens 514-1 and 514-2, each of which may include:
   a use restriction 516 (e.g., an electronic locking device);
   a token expiration time 518 (e.g., before 5 pm of the day that is one week after the date on which an order is placed); and
   a passcode 520 (e.g., for unlocking the electronic locking device)
an access control module 168 for identifying access restrictions at a user-specified location and use restrictions on an access token;
a delivery management module 170 for maintaining delivery status data; and
data 522 stored on the system 500, which may include:
   a user database 162, which may store information identifying one or more user accounts 524, each of which may include:
      a home appliance identifier 524 for identifying an appliance (e.g., an air conditioner, a fan, a freezer, and a light) present at a user-specified location;
      a Wi-Fi password 528 for accessing a Wi-Fi network available at the user-specified location;
      a home security system password 530 for accessing a home security system present or armed at the user-specified location; and
      an electronic bolt password 532 for automatically and electronically locking and unlocking an electronic bolt; and
   a delivery database 164 for maintaining one or more delivery confirmations 534.

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 506 optionally stores a subset of the modules and data structures identified above. Furthermore, the memory 506 may store additional modules and data structures not described above.

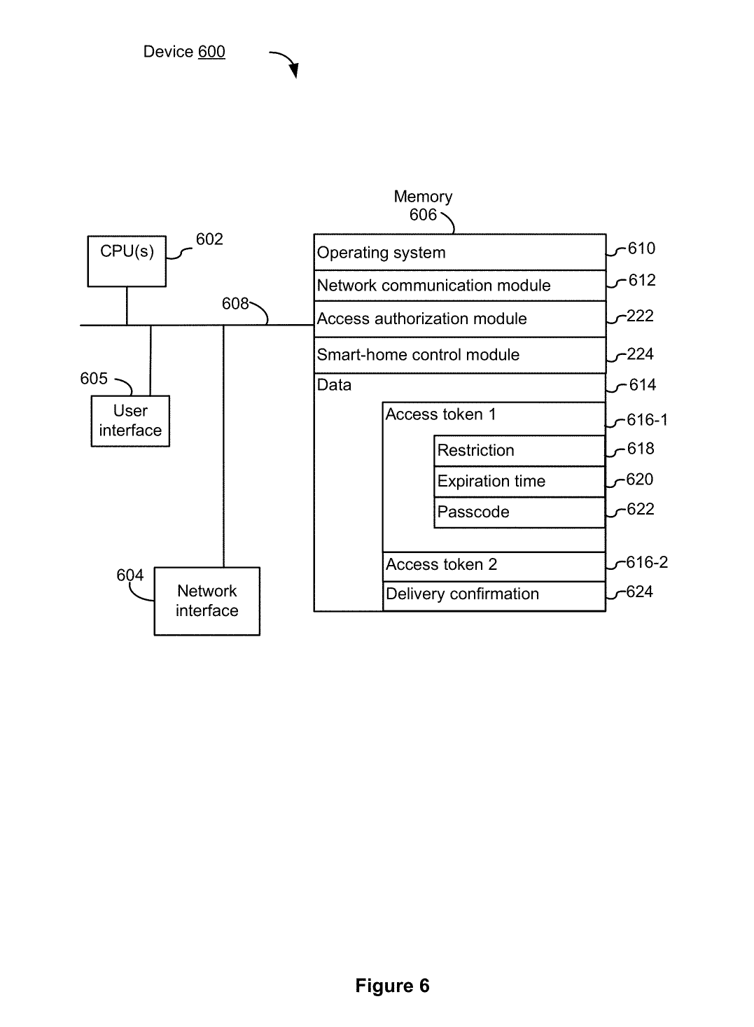

FIG. 6 is a schematic view illustrating an embodiment of a user device 600, which can be the delivery device 202 shown in FIG. 1. The device 600 in some implementations includes one or more processing units CPU(s) 602 (also referred to as hardware processors), one or more network interfaces 604, a user interface 605, a memory 606, and one or more communication buses 608 for interconnecting these components. The communication buses 608 optionally include circuitry (sometimes called a chipset) that interconnects and controls communications between system components. The memory 606 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. The memory 606 optionally includes one or more storage devices remotely located from the CPU(s) 602. The memory 606, or alternatively the non-volatile memory device(s) within the memory 606, comprises a non-transitory computer readable storage medium. In some implementations, the memory 606 or alternatively the non-transitory computer readable storage medium stores the following programs, modules and data structures, or a subset thereof:
an operating system 610, which includes procedures for handling various basic system services and for performing hardware dependent tasks;
a network communication module (or instructions) 612 for connecting the device 600 with other devices (e.g., the delivery service system 106 and a user device 102) via one or more network interfaces 604 (wired or wireless) or via the communication network 104 (FIG. 1);
an access authorization module 222 for authorizing whether an access token can be used to remove an access restriction at a user-specified location;
a smart-home control module 224 for communicating with (e.g., unlocking) a smart-home device (e.g., an office or home appliance and an electronic lock);
data 614 stored on the device 600, which may include:
   an access token 616-1 for removing one or more access restrictions and may include or encode:
      one or more use restrictions 618;
      a token expiration time 620; and
      a passcode 622 for unlocking an electronic device (e.g., a lock);
   an access token 616-2 for removing a same or different restriction; and
   a delivery confirmation 624.

The device 600 may further include a location determination component (e.g., a Global Positioning System (GPS) device and a cell tower triangulation device) for providing location information of the device 600. The delivery service system may use the location of the device 600 when providing the access token “as needed” feature discussed above.

In some implementations, one or more of the above identified elements are stored in one or more of the previously mentioned memory devices, and correspond to a set of instructions for performing a function described above. The above identified modules or programs (e.g., sets of instructions) need not be implemented as separate software programs, procedures or modules, and thus various subsets of these modules may be combined or otherwise re-arranged in various implementations. In some implementations, the memory 606 optionally stores a subset of the modules and data structures identified above. Furthermore, the memory 606 may store additional modules and data structures not described above.

Although FIGS. 5 and 6 show a “system 500” and a “device 600,” respectively, FIGS. 5 and 6 are intended more as functional description of the various features which may be present in computer systems than as a structural schematic of the implementations described herein. In practice, and as recognized by those of ordinary skill in the art, items shown separately could be combined and some items could be separated.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. For example, the above embodiments have focused on merchants and users; however, a user or consumer can pay, or otherwise interact with any type of recipient, including charities and individuals. The payment does not have to involve a purchase, but may be a loan, a charitable contribution, a gift, etc. Thus, merchant as used herein can also include charities, individuals, and any other entity or person receiving a payment from a user. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system, comprising:
a non-transitory memory; and
one or more hardware processors coupled to the non-transitory memory and configured to execute instructions from the non-transitory memory to cause the system to perform operations comprising:
identifying a transaction that includes a physical delivery of an item to a user-specified location;
responsive to the identifying, obtaining an access token based at least in part on one or more access restrictions associated with the user-specified location; and
electronically communicating the access token available to a device corresponding to a party associated with the physical delivery of the item, wherein the access token enables the party to enter a predefined secured subarea within the user-specified location.

2. The system of claim 1, wherein the operations further comprise:
determining a weather condition associated with the physical delivery of the item to the user-specified location; and
generating the access token based at least in part on the weather condition.

3. The system of claim 2, wherein predefined secured subarea includes an area that is protected from the weather condition.

4. The system of claim 1, wherein the operations further comprise:
determining a physical characteristic of the item; and
identifying an access restriction for inclusion in the one or more access restrictions based on the physical characteristic of the item.

5. The system of claim 1, wherein the operations further comprise:
determining a user availability associated with the physical delivery of the item to the user-specified location; and
generating the access token based at least in part on the user availability.

6. The system of claim 5, wherein the access token does not enable entry to the predefined secured subarea during a time frame within the user availability.

7. The system of claim 5, wherein determining the user availability comprises determining the user availability, without user input, from a user appointment recording application.

8. The system of claim 1, wherein the operations further comprise:
determining that the physical delivery of the item has been completed;
responsive to the determining, disabling the access token; and
transmitting a delivery alert over a wireless communication channel to a user device;
wherein delivery alert activates a delivery status viewing application to cause delivery information to be displayed on the user device when the user device is connected with the system through a predefined communication channel.

9. The system of claim 7, wherein the delivery information comprises a photo or video confirmation of the physical delivery.

10. The system of claim 1, wherein the one or more access restrictions include one of: a home security system, an electronic lock, an electronic bolt, a door, a window, and a ceiling opening.

11. The system of claim 1, wherein the party includes a drone and the transaction includes an online transaction.

12. The system of claim 1, wherein the item includes a user-selected service.

13. A method, comprising:
receiving transaction data for a purchase of an item to be delivered, wherein the transaction data comprises a delivery location;
obtaining access data for the delivery location;
generating an electronic access token based on the access data and the transaction data; and
communicating the electronic access token to a device associated with a delivery of the item to the delivery location, wherein the electronic access token enables limited access to a first access location of the delivery location.

14. The method of claim 13, further comprising: determining the device has accessed the first access location; and responsive to the determining, disabling the electronic access token.

15. The method of claim 14, further comprising: responsive to the determining, securing the first access location.

16. The method of claim 13, wherein generating the electronic access token includes generating the electronic access token in accordance with a symmetric encryption-decryption algorithm.

17. The method of claim 13, wherein communicating the electronic access token to the device includes: encrypting a password associated with the delivery location to produce the electronic access token; and transmitting a key associated with the symmetric encryption-decryption algorithm to the device.

18. The method of claim 13, wherein communicating the electronic access token to the device includes: determining that the device is within a predefined proximity to the delivery location; and responsive to the determining, communicating the electronic access token to the device.

19. The method of claim 13, wherein the transaction data includes one of: a time frame associated with the delivery, an address of the delivery location, and an operating time of the delivery location.

20. A non-transitory machine-readable medium having stored thereon machine-readable instructions executable to cause a machine to perform operations comprising:
receiving transaction data for a purchase of an item to be delivered, wherein the transaction data comprises a delivery location;
obtaining access data for the delivery location;
generating an electronic access token based on the access data and the transaction data; and
communicating the electronic access token to a device associated with a delivery of the item to the delivery location, wherein the electronic access token enables limited access to a first access location of the delivery location.
